(19) United States
(12) Patent Application Publication
(10) Pub. No.: US 2009/0272700 A1
(43) Pub. Date: Nov. 5, 2009

(54) METHOD FOR REMOVING ORGANIC CONTAMINANTS

(76) Inventors: Shu-Hung YANG, Taipei (TW); Shou-Li Luo, Taipei (TW)

Correspondence Address: BIRCH STEWART KOLASCH & BIRCH, PO BOX 747, FALLS CHURCH, VA, 22040-0747, US

(21) Appl. No.: 12/502,838

(22) Filed: Jul. 14, 2009

Related U.S. Application Data
(62) Division of application No. 11/727,819, filed on Mar. 28, 2007.

(30) Foreign Application Priority Data
Mar. 29, 2006 (TW) 095110889

(51) Int. Cl. B01D 17/00

(52) U.S. Cl. 210/766

(57) ABSTRACT

This invention provides a method for removing organic contaminants from an inorganic processing solution, comprising the step of: introducing the inorganic processing solution comprising organic contaminants into steam stripping treatment; heating the inorganic processing solution; reintroducing the inorganic processing solution into the steam stripping treatment; and removing the organic contaminants from the inorganic processing solution, thereby the inorganic processing solution comprises a total carbon content not more than 300 ppm, based on the total amount of the inorganic processing solution; wherein the step of heating is performed by heat exchange between the inorganic processing solution and desuperheated steam.

### CROSS REFERENCE TO RELATED APPLICATIONS

This application is a Divisional of co-pending application Ser. No. 11/727,819 filed Mar. 28, 2007, and for which priority is claimed under 35 U.S.C. §120. This application claims priority of Application No. 095110889, filed in Taiwan, Republic of China on Mar. 29, 2006, the entire contents of which are hereby incorporated by reference.

### FIELD OF THE INVENTION

The present invention relates to a method for treating an inorganic processing solution. More particularly, the present invention relates to a a method for removing organic contaminants from an inorganic processing solution used in a recycling system for producing hydroxylamine oxime.

### BACKGROUND OF THE INVENTION

Caprolactam is an important starting material for producing polyamide (also referred to as nylon). Currently, a commercial process for preparing caprolactam involves generating cyclohexanone oxime in a hydroxylamine-oixme recycling system, and then subjecting the oxime to the Beckmann rearrangement to yield caprolactam. In a hydroxylamine-oxime recycling system, the reaction performance of hydroxylamine synthesis depends on the degree of clearness of the inorganic processing solution used. After oxime reaction, the inorganic processing solution contains organics, such as carboxylic acids, alcohols, aldehydes, ketones, esters, ethers, hydrocarbons, and the like. Typically, most of the product and other organics can be separated from the solution by extraction. However, the extracted solution still contains a trace of undesired organics. If such an inorganic processing solution with trace organics is recycled into a reaction zone of hydroxylamine synthesis, the catalysts in the reaction zone will be poisoned. Therefore, the undesired organics in the inorganic processing solution are subject to organic contaminants. Usually, the inorganic processing solution after oxime reaction is firstly extracted, so as to remove most of the product and other organics before entering the reaction zone, and then stripped with steam to eliminate residual organic contaminants.

In a hydroxyl-oxime recycling system, steam stripping is mainly used for the purpose of evaporating excess water in the recycling system, thereby controlling the content of water in the whole system. Additionally, a trace of organic contaminants remained in the inorganic processing solution, such as cyclohexanone, cyclohexanone oxime and toluene, can also be eliminated by steam stripping, wherein cyclohexanone oxime can be hydrolyzed into cyclohexanone and hydroxylamine.

Referring to FIG. 1, a schematic view of a prior steam stripping device is shown. It comprises a steam stripping tower A and a reboiler B for heating the inorganic processing solution. In the hydroxylamine-oxime recycling system, the inorganic processing solution after oxime reaction is firstly extracted (not shown) with organic solvents, such as toluene, so as to eliminate most of the product of cyclohexanone-oxime, unreacted cyclohexanone and other organics, such as carboxylic acids, alcohols, aldehydes, ketones, esters, ethers, hydrocarbons, and the like. After that, the extracted inorganic processing solution is introduced into the steam stripping tower A through a pipe 10, then led into a reboiler B through a pipe 12, and delivered back to the steam stripping tower A through a pipe 14. Stream is introduced into the reboiler B through a pipe 20, passing through a control valve 100, to heat the inorganic processing solution. Excess water and organics are discharged form a pipe 16 at the top of steam stripping tower A, and the stripped inorganic processing solution flows out from a pipe 18 at the bottom of the steam stripping tower A.

However, it would be desirable to provide a method for preventing degradation of inorganic processing solution due to superheating.

### SUMMARY OF THE INVENTION

To overcome the above-mentioned problems of the prior art, it is an object of this invention to provide a method for inorganic processing solution that can prevent deterioration and degradation of the inorganic processing solution.

This invention provides a method for removing organic contaminants from an inorganic processing solution, comprising the step of: introducing the inorganic processing solution comprising organic contaminants into steam stripping treatment; heating the inorganic processing solution; reintroducing the inorganic processing solution into the steam stripping treatment; and removing the organic contaminants from the inorganic processing solution, thereby the inorganic processing solution comprises a total carbon content not more than 300 ppm, based on the total amount of the inorganic processing solution; wherein the step of heating is performed by heat exchange between the inorganic processing solution and desuperheated steam.

Ideally, a corresponding steam condition to each steam stripping device should be provided, that is, one heat exchanger should be equipped with one suitable boiler or steam supply system. However, when the costs and efficiency are considered, it is very often to use only one main steam supply system in the entire factory. That is, only one main boiler is used for the whole factory to distribute steam to each unit of the factory through pipes and control valves according to the requirements of temperature, pressure and consumption. The flow of steam into each unit is controlled by the control valve. However, the steam of reduced pressure caused by passing through the control valve is always superheated. Because making the performance of heat transfer of the superheated steam is only about one tenth of that for the saturated steam, it adversely affects the heat exchanging efficiency in the heat exchanging unit.

The inventors found the use of superheated steam to heat the inorganic processing solution containing a trace of organic contaminants will cause partially superheating and has several disadvantages. For example, due to the high temperature, organic contaminants such as ketones and alcohols, will react to form compounds with higher molecular weight and result in the decrease of product yield; crystallization and blocking of the heat exchanging devices and pipes by the discharged basic solution, and the color-change of processing inorganic solution at high temperature, etc. Therefore, the inventors develop the above method for improving the removing rate of organic contaminants from an inorganic processing solution.

Another object of this invention is to provide a steam stripping device for an inorganic processing solution that can remove organic contaminants efficiently. To achieve the aforementioned and other objects, a steam stripping device for inorganic processing solution is provided, comprising a steam stripping unit for steam stripping the inorganic processing solution; a heat exchanging unit coupled to the steam stripping unit, for heating the inorganic processing solution introduced into the steam stripping unit by means of a steam fed into the heat exchanging unit; and a desuperheating unit for lowering by cooling liquid the temperature of the steam when superheated before the steam is fed into the heat exchanging unit. This device can be used for steam stripping of the inorganic processing solution in a hydroxyl-oxime recycling system, thereby removing organic contaminants in the inorganic processing solution. By the provision of a desuperheating unit in the steam stripping device of this invention, the adverse influence of inorganic processing solution caused by partially superheating during steam stripping can be avoided, and organic contaminants can be removed from the inorganic processing solution efficiently. Moreover, as mentioned before, superheated steam has a relatively inferior performance of heat transfer than that of saturated steam by 10 times, which seriously influence the efficiency of heat exchange in the heat exchanging unit. The steam stripping device of this invention can efficiently avoid superheated steam to enter the heat exchange unit. Since the coefficient of heat transfer can be significantly enhanced, it can increase the efficiency of steam stripping capacity of the process.

### BRIEF DESCRIPTION OF THE DRAWINGS

FIG. 1 is a schematic view of a prior steam stripping device;

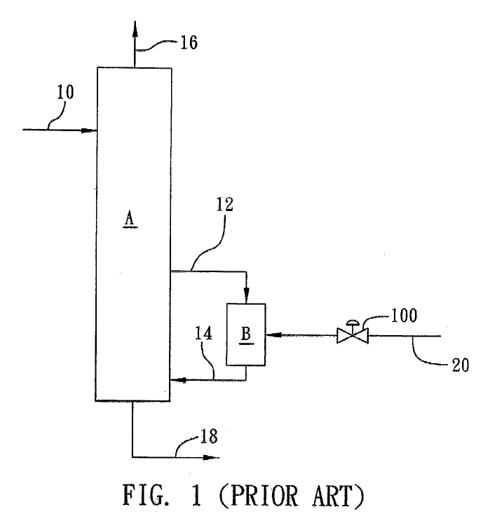

FIG. 2 is a schematic view of the steam stripping device according to the embodiment of the present invention; and

FIG. 3 is a schematic view of interior elements of the desuperheating unit according to the present invention.

### DETAILED DESCRIPTION OF THE PREFERRED EMBODIMENTS

The following illustrative embodiments are provided to illustrate the disclosures of the present invention. These and other advantages and effects can be apparently understood by those skilled in the art after reading this specification. The present invention can also be performed or applied by other different embodiments. The details of the specification may be modified and varied on the basis of different points and applications without departing from the spirit of the present invention.

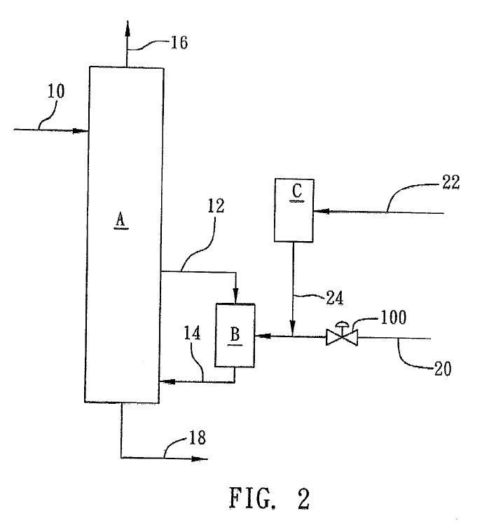

FIG. 2 is a schematic view of the steam stripping device for an inorganic processing solution according to the embodiment of the present invention. The steam stripping device is composed of a steam stripping unit, such as steam stripping tower A; a heat exchanging unit for heating the inorganic processing solution by means of a steam fed into the heat exchanging unit, such as reboiler B; and a desuperheating unit for lowering by cooling liquid the temperature of superheated steam (preferably, the temperature is lowered to the level of saturation) before the steam is fed into the heat exchanging unit, such as desuperheating apparatus C. In this embodiment, the steam stripping device and efficacy thereof are illustrated by using phosphate inorganic processing solution in the hydroxylamine-oxime recycling system.

Firstly, in the hydroxylamine-oxime recycling system, after the formation of cyclohexanone-oxime, the phosphate inorganic processing solution is isolated and introduced into the steam stripping tower A through a pipe 10. The inorganic processing solution contains phosphate salts, hydroxylamine, water, and organics. The organics includes ketones such as cyclohexanone; ketone oximes, such as cyclohexanone oxime; carboxylic acids; alcohols; aldehydes; esters; amines; and hydrocarbons such as toluene, etc.

Secondly, the inorganic processing solution in the steam stripping tower A is introduced into the reboiler B through a pipe 12 for heating, and then reintroduced into steam stripping tower A through a pipe 14. During the process of steam stripping, excess water and undesired organics are expelled from the top of the steam stripping tower A through a pipe 16. Among those, the expelled organics are recovered by cooling. The inorganic processing solution stripped with steam to remove excess water and organic contaminants then flows out from the bottom of the steam stripping tower A through a pipe 18. Subsequently, the composition of the solution is adjusted according to requirement. For example, the solution is delivered to a nitric acid absorbing tower for supplementing nitrate ions so as to carry out the following hydroxylamine synthesis.

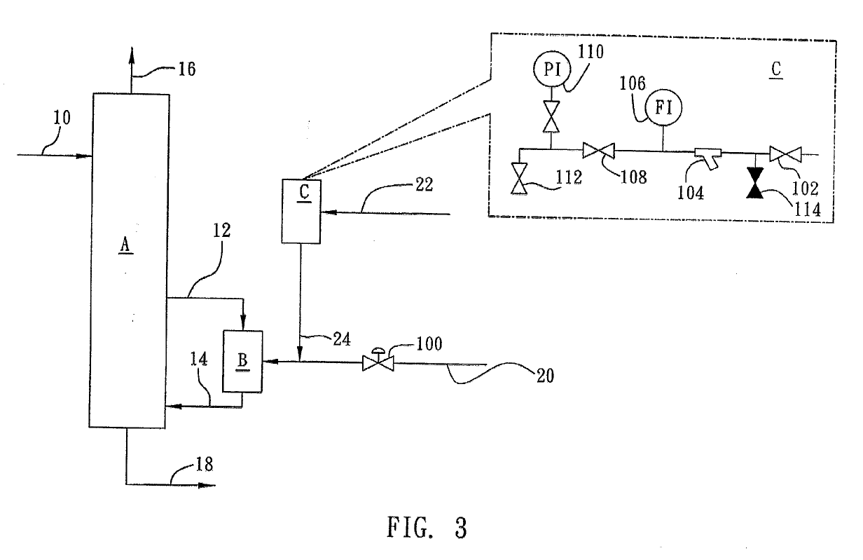

The steam used in this steam stripping device is introduced into reboiler B through a pipe 20, thereby heating the inorganic processing solution. Generally, the steam is supplied by a single steam-electricity cogeneration plant in the factory. The steam may be of high pressure steam, middle pressure steam, or low pressure steam, which is not designed according to the required condition of a particular device. Meanwhile the flow of steam is regulated by a control valve 100 to be led into reboiler B. Since the steam is easily overheated during transmission in the present invention, a desuperheating unit C is disposed at the steam inlet of the reboiler B. Cooling liquid, such as boiler feed water, is introduced into the desuperheating unit C through a pipe 22 to lower the temperature of the superheated steam by spraying through a pipe 24. Successively, the cooled steam is introduced into reboiler B so as to prevent adverse influence on the inorganic processing solution caused by superheated steam. FIG. 3 further describes the interior elements of the desuperheating unit. The desuperheating unit C comprises an inlet block valve 102, a Y filter 104, a flow indicator 106, a block valve 108, a pressure indicator 110, a block valve 112, and an outlet valve 114. In this embodiment, the boiler feed water is used as a cooling liquid. The boiler feed water flows into the desuperheating unit C through the pipe 22, passing through the inlet block valve 102. Then, the boiler feed water passes through Y filter 104 and impurities are filtered. After successively passing through the flow indicator 106, block valve 108, pressure indicator 110, and block 112, the cooling water is sprayed through the nozzle of the desuperheating unit to lower the temperature of superheated steam and then the cooled steam is introduced into the reboiler B.

In the steam stripping device for an inorganic processing solution of the present invention, the desuperheating unit disposed at the steam inlet of the reboiler is used to lower the temperature of superheated steam by spraying water when the temperature of the introduced steam becomes too high. After the temperature is lowered, the steam is reintroduced into the reboiler. Thereby, thermal decomposition of organics into other organic compounds, such as organic acids, cyclic compounds, and carbon complexes, in the inorganic processing solution can be avoided. Furthermore, the organic contaminants can also be efficiently removed. In this embodiment, the total carbon content in the steam stripped phosphate inorganic processing solution used in the hydroxylamine-oxime recycling system, based on the total amount of phosphate inorganic processing solution, is preferably not more than 0.03 wt % (300 ppm), preferably not more than 0.02 wt % (200 ppm), further more preferably not more than 0.015 wt % (150 ppm), and most preferably not more than 0.01 wt % (100 ppm); the total amount of cyclohexanone and cyclohexanone-oxime together preferably not more than 0.001 wt % (10 ppm), more preferably not more than 0.0005 wt % (5 ppm), further more preferably not more than 0.0003 wt % (3 ppm), and most preferably not more than 0.0002 wt % (2 ppm).

Additionally, the steam stripping device of the present invention can prevent the denature of inorganic processing solution due to superheating. Accordingly, when the steam stripping device is applied to hydroxylamine-oxime recycling system, not only the efficiency of removing organic contaminants can be enhanced, but also can prevent the denature of inorganic processing solution. Thereby, it can prevent the decreases of catalyst activity and selectivity of hydroxylamine production in the hydroxylamine synthesis.

### EXAMPLES

### Example 1

The phosphate inorganic processing solution, after conducting oxime reaction to form cyclohexanone oxime in a hydroxylamine-oxime recycling system and being isolated by extraction, was used. Total carbon, amount of cyclohexanone and cyclohexanone-oxime, and amount of toluene in the solution were analyzed. The results obtained are shown in Table 1.

The phosphate inorganic processing solution was stripped with low pressure steam having 5 kg/cm² (at 161° C.) under conditions of atmospheric pressure and 110° C. in the steam stripping device with desuperheating unit of the present invention. When steam stripping was completed, total carbon, amount of cyclohexanone and cyclohexanone oxime, and amount of toluene in the solution were measured. The results are shown in Table 1.

TABLE 1
organics in the inorganic processing solution

| | total carbon | cyclohexanone and | toluene |
|---|---|---|---|
| | (ppm) | cyclohexanone-oxime (ppm) | (ppm) |
| before steam | 365 | 123 | 265 |
| stripping | | | |
| after steam | 103 | 0.5 | 0 |
| stripping | | | |
| removal of | 71.8% | 99.6% | 100% |
| organics | | | |

### Comparative Example 1

The procedures of Example 1 were repeated except that a steam stripping tower without a desuperheating unit was used. The results obtained are shown in Table 2.

TABLE 2
organics in the inorganic processing solution

| | total carbons | cyclohexanone and | toluene |
|---|---|---|---|
| | (ppm) | cyclohexanone-oxime (ppm) | (ppm) |
| before steam | 358 | 115 | 260 |
| stripping | | | |
| after steam | 126 | 2.2 | 0 |
| stripping | | | |
| Removal of | 64.8% | 98.1% | 100% |
| organics | | | |

The foregoing detailed descriptions of the embodiments have been discussed for illustrating the features and functions of the present invention but not for limiting the scope of the present invention. Those skilled in the art will appreciate that modifications and variations according to the spirit and principle of the present invention may be made. All such modifications and variations are considered to fall within the spirit and scope of the present invention as defined by the appended claims.

What is claimed is:

1. A method for removing organic contaminants from an inorganic processing solution, comprising the step of:
introducing the inorganic processing solution comprising organic contaminants into steam stripping treatment;
heating the inorganic processing solution;
reintroducing the inorganic processing solution into the steam stripping treatment; and
removing the organic contaminants from the inorganic processing solution, thereby the inorganic processing solution comprises a total carbon content not more than 300 ppm, based on the total amount of the inorganic processing solution;
wherein the step of heating is performed by heat exchange between the inorganic processing solution and desuperheated steam.

2. The method according to claim 1, wherein the inorganic processing solution is used in a recycling system for producing hydroxylamine-oxime.

3. The method according to claim 2, wherein the inorganic processing solution comprises phosphate salts, hydroxylamine, water, and organics.

4. The method according to claim 1, wherein the organic contaminants is selected from a group consisting of ketone, ketoxime, carboxylic acid, alcohol, aldehyde, ester, amine and hydrocarbon.

5. The method according to claim 1, wherein the desuperheated steam is prepared by lowering temperature of superheated steam.

6. The method according to claim 2, wherein the desuperheated steam is prepared by lowering temperature of superheated steam by using cooling liquid.

7. The method according to claim 1, further comprises extracting the inorganic processing solution comprising organic contaminants before steam stripping treatment.
